(19) United States
(12) Patent Application Publication
(10) Pub. No.: US 2017/0168768 A1
(43) Pub. Date: Jun. 15, 2017

(54) CONTENT DISPLAYING METHOD AND DEVICE

(71) Applicant: Beijing Zhigu Rui Tuo Tech Co., Ltd, Beijing (CN)

(72) Inventors: Jia LIU, Beijing (CN); Hongjiang ZHANG, Beijing (CN)

(21) Appl. No.: 15/115,662

(22) PCT Filed: Jan. 15, 2015
(86) PCT No.: PCT/CN2015/070756

§ 371 Date: Jul. 29, 2016

(30) Foreign Application Priority Data
Feb. 28, 2014 (CN) 201410072176.8

(51) Int. Cl. G06F 3/14; H04B 1/3827; H04W 4/00

(52) U.S. Cl. CPC G06F 3/1423; H04W 4/008; H04W 4/005; H04B 1/385

(57) ABSTRACT

A content displaying method and device are provided. A method comprises: receiving, by a display device, a content display request from a request device; obtaining to-be-displayed content according to the content display request; and displaying the to-be-displayed content in response to the distance between the display device and the request device does not exceed a first distance. A display solution provides a user with choices of the display device through inter-device interactions.

### RELATED APPLICATION

The present international patent cooperative treaty (PCT) application claims the benefit of priority to Chinese Patent Application No. 201410072176.8, filed on Feb. 28, 2014, and entitled “Content Displaying Method and Device”, which is hereby incorporated into the present international PCT application by reference herein in its entirety.

### TECHNICAL FIELD

Embodiments of the present application relate to the field of inter-device interaction technologies, and particularly, relate to a content displaying method and device.

### BACKGROUND

With continuous advances of technologies, wearable technologies have been gradually entering people's daily life. Wearable devices, such as smart watches, smart glasses, and smart earrings, further widen human-machine interaction approaches, to cause that the connections between people and the outside world become freer, smoother, and more convenient. As can be predicted, users will not only have conventional mobile devices such as notebook computers, smart phones, and tablet computers, but also wear and use various wearable devices. The two types of devices each have advantages in aspects of portability, ease to use, and processing capability, and can be used in different scenarios to meet specific requirements. Also, these devices generally support various wireless communication technologies, such as the data cellular network, Wi-Fi, Bluetooth, infrared and so on. The device-to-device connection and coordination may also become extremely convenient.

Due to restrictions for some wearable devices in aspects such as energy capacity of battery, computing performance, storage capacity, and display capability, not all content is suitable to be displayed on the wearable devices. For example, when a mobile phone receives a picture or a video, a smart watch connected to the mobile phone informs a user of the message and displays a thumbnail of the picture or a screenshot of the video. The user receives the notification and wants to view the specific content, but it is not suitable to display the specific content due to restraints such as the screen size, resolution, and power consumption of the smart watch.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed descriptions of the various embodiments that follow in the disclosure.

In view of this, an example objective of embodiments of the present application is to provide a display solution.

According to one example aspect of the embodiments of the present application, a content displaying method is provided, comprising:

receiving, by a display device, a content display request from a request device;

obtaining to-be-displayed content according to the content display request; and

displaying the to-be-displayed content in response to the distance between the display device and the request device does not exceed a first distance.

According to another example aspect of the embodiments of the present application, a content displaying method is provided, comprising:

sending, by a request device, a content display request to a display device, wherein the content display request comprises an identifier and/or address of to-be-displayed content; and

sending a display instruction to the display device in response to the distance between the request device and the display device does not exceed a first distance, wherein the display instruction is used for instructing the display device to display the to-be-displayed content.

According to another example aspect of the embodiments of the present application, a display device is provided, comprising:

a receiving module, configured to receive a content display request from a request device;

an obtaining module, configured to obtain to-be-displayed content according to the content display request; and

a display module, configured to display the to-be-displayed content in response to the distance between the display device and the request device does not exceed a first distance.

According to another example aspect of the embodiments of the present application, provided is a request device, comprising:

a first sending module, configured to send a content display request to a display device, wherein the content display request an identifier and/or address of to-be-displayed content; and

a second sending module, configured to send a display instruction to the display device in response to the distance between the request device and the display device does not exceed a first distance, wherein the display instruction is used for instructing the display device to display the to-be-displayed content.

At least one of the aforementioned multiple technical solutions has the following example non-limiting beneficial effects:

The embodiments of the present application provide a display solution through that the display device receives a content display request from the request device, obtains to-be-displayed content according to the content display request, and displays the to-be-displayed content in response to the distance between the display device and the request device does not exceed a first distance, and provide a user with choices of the display device through inter-device interactions.

### BRIEF DESCRIPTION OF THE DRAWINGS

FIG. 1 is an example flowchart of a first embodiment of a content displaying method provided in the present application;

FIG. 2 is an example flowchart of a second embodiment of a content displaying method provided in the present application;

FIG. 3a is an example structural diagram of a first embodiment of a display device provided in the present application;

FIG. 3b to FIG. 3e each is an example structural diagram of an embodiment shown in FIG. 3a;

FIG. 4a is a structural diagram of a first embodiment of a request device provided in the present application;

FIG. 4b and FIG. 4c each is a structural diagram of an embodiment shown in FIG. 4a;

FIG. 5 is a structural diagram of a second embodiment of a display device provided in the present application; and

FIG. 6 is a structural diagram of a f second irst embodiment of a request device provided in the present application.

### DETAILED DESCRIPTION

The following further describes, in detail, the detailed description of the present application with reference to accompanying drawings and embodiments. The embodiments below are for illustration of the present application only, but are not limitative of the disclosure of the present application.

Persons skilled in the art should understand that the “display device” in the present application can generally be understood as any device capable of displaying, comprising but not limited to: a wearable device, a mobile phone, a personal digital assistant (PDA), a tablet computer, a smart television set, and the like.

Persons skilled in the art could understand that the “request device” in the present application can generally be understood as any device, comprising but not limited to: a wearable device, a mobile phone, a PDA, a tablet computer, a smart television set, and the like.

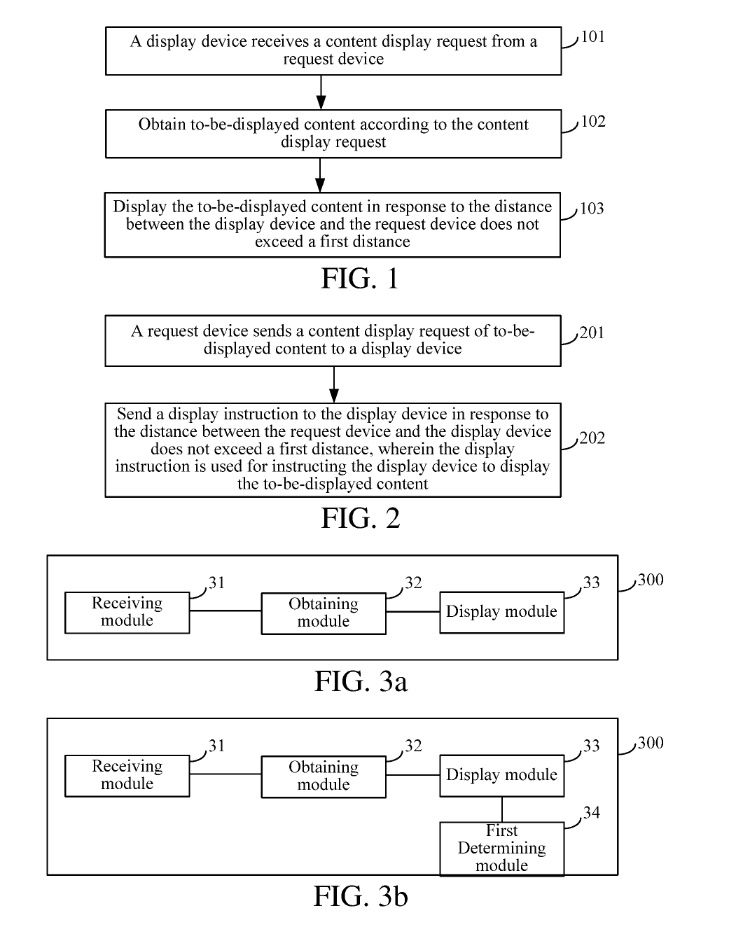

FIG. 1 is a flowchart of Embodiment 1 of a content displaying method provided in the present application. As shown in FIG. 1, this embodiment comprises:

101: A display device receives a content display request from a request device.

Optionally, the content display request comprises: an identifier and/or address of to-be-displayed content. Herein, the identifier of the to-be-displayed content may comprise a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address.

102: Obtain to-be-displayed content according to the content display request.

Specifically, the to-be-displayed content comprises but not limited to at least one of: a picture, a video, a text message, and the like.

In an optional embodiment, the obtaining to-be-displayed content according to the content display request comprises:

obtaining a part or the whole of the to-be-displayed content from the display device locally or externally according to the content display request.

For example, if the to-be-displayed content is stored in the display device, the content display request may only comprise an identifier of the to-be-displayed content; or, the content display request may only comprise a storage path of the to-be-displayed content in the display device; or, the content display request may comprise an identifier of the to-be-displayed content and a storage path of the to-be-displayed content in the display device, and accordingly, the display device obtains a part or the whole of the to-be-displayed content locally. If the to-be-displayed content is stored in another device, the content display request may only comprise an identifier of the to-be-displayed content, and accordingly, the display device searches, in a local area network or through a search engine, for and obtains the to-be-displayed content from another device; or, the content display request may comprise an address of the to-be-displayed content, and accordingly, the display device obtains a part or the whole of the to-be-displayed content from the another device according to the address of the to-be-displayed content.

Generally, if the data size of the to-be-displayed content is small, the whole of the to-be-displayed content may be obtained directly. If the data size of the to-be-displayed content is large, a part of the to-be-displayed content may be obtained first and further, the other part of the to-be-displayed content may be obtained during a display process.

In another optional embodiment, the content display request further comprises: a part or the whole of the to-be-displayed content.

Optionally, the obtaining to-be-displayed content according to the content display request comprises:

obtaining a part or the whole of the to-be-displayed content from the content display request.

For example, if the content display request comprises the whole of the to-be-displayed content, the display device obtains the whole of the to-be-displayed content from the content display request; or, first obtains a part of the to-be-displayed content from the content display request and then obtains the other part of the to-be-displayed content from the content display request during a display process. If the content display request comprises a part of the to-be-displayed content and an address of the to-be-displayed content, the display device obtains the part of the to-be-displayed content from the content display request and then obtains the other part of the to-be-displayed content according to the address of the to-be-displayed content during a display process.

103: Display the to-be-displayed content in response to the distance between the display device and the request device does not exceed a first distance.

In an optional embodiment, the display device determines whether the distance between the display device and the request device does not exceed the first distance, and displays the to-be-displayed content in response to a result is yes. Herein, multiple approaches are used for determining. Optionally, the method further comprises:

determining, by the display device, whether the distance between the display device and the request device does not exceed the first distance according to the strength of a signal received from the request device.

Specifically, the Bluetooth low energy (BLE) is used as an example to introduce how to determine whether an inter-device distance exceeds a certain distance according to signal strength. A proximity profile of the BLE defines how to perform proximity monitoring between two devices, that is, between a monitor and a reporter. The basic principles are as follows:

a monitor first establishes a BLE link with a reporter;

the monitor performs service discovery, wherein relevant services that can be discovered comprise: a link loss service, an immediate alert service, and a transmit power service (Tx Power service);

subsequently, the monitor executes characteristic discovery to obtain characteristics of the three services, for example, a current transmit power value Tx Power provided by the transmit power service; and thereafter, the monitor continuously detects a receiving signal strength indication (RSSI) of a signal from the reporter, and calculates a link loss according to the following formula:

link loss=Tx Power−RSSI.

On the basis of the principles, in this embodiment, a BLE link is established between the display device and the request device. The display device acts as the monitor and the request device acts as the reporter. The display device detects an RSSI of a signal from the request device, further calculates a link loss between the display device and the request device, compares the link loss obtained through calculation with a preset link loss threshold, wherein the link loss threshold is corresponding to the first distance, that is, the distance between the display device and the request device is the first distance when the link loss between the display device and the request device is the link loss threshold, and if the link loss obtained through calculation does not exceed the link loss threshold, the display device determines that the distance between the display device and the request device does not exceed the first distance. It should be noted that when the environment (such as, a barrier position and air humidity) changes, the distance corresponding to the same link loss may change.

Optionally, the method further comprises:

determining, by the display device, whether the distance between the display device and the request device does not exceed the first distance according to a location of the display device and a location of the request device.

Specifically, the position of the display device and the position of the request device can be obtained through positioning technologies, such as, the Global Positioning System (GPS) positioning, and the indoor positioning.

Optionally, the first distance is set by a user, for example, set to be 2 meters (m), 0.5 m, and 0.1 m.

In another optional embodiment, the display device determines whether the distance between the display device and the request device does not exceed the first distance, and triggers displaying of the display device in response to a result is yes. Optionally, the displaying the to-be-displayed content in response to the distance between the display device and the request device does not exceed a first distance comprises:

receiving a display instruction from the request device, wherein the display instruction is sent by the request device in response to the request device determines that the distance between the request device and the display device does not exceed the first distance; and

displaying, by the display device, the to-be-displayed content according to the display instruction.

Specifically, the request device may determine whether the distance between the request device and the display device does not exceed the first distance by using a method similar to the above mentioned method of the display device.

In any one of the embodiments or scenarios, a user may further be requested for a confirmation before the displaying. Specifically, the displaying the to-be-displayed content in response to the distance between the display device and the request device does not exceed a first distance comprises:

prompting a user in response to the distance between the display device and the request device does not exceed the first distance; and

displaying the to-be-displayed content according to a display confirmation from the user.

Herein, there are multiple methods for prompting the user. For example, a window is presented on a display interface of the display device, a user is requested to determine whether to perform displaying, and when the user clicks a “confirm” button in the window, the display device receives a display confirmation from the user and then performs displaying.

Optionally, if the display confirmation from the user is not received after the user is prompted, the to-be-displayed content is not displayed.

Optionally, in the embodiment in which the request device detects to determine whether the distance between the request device and the display device does not exceed the first distance, the display device prompts the user after receiving the display instruction from the request device and displays the to-be-displayed content according to the display confirmation from the user.

In any one of the embodiments or scenarios, the content display request further comprise: a display type. The display type comprises at least one of the followings: opening, playing, zooming in, and full screen.

The displaying the to-be-displayed content comprises:

displaying the to-be-displayed content according to the display type.

Specifically, the corresponding display type may be slightly disparate for different to-be-displayed content. For example, when the to-be-displayed content is a picture: if the display type is opening, the display device selects software capable of opening the picture to open the picture; if the display type is zooming in, the display device zooms in the picture according to a preset multiple on the basis of the opening the picture; and if the display type is full screen, the display device displays the picture in full screen on the basis of the opening the picture. When the to-be-displayed content is a video: if the display type is opening, the display device selects software capable of opening the video to open the video, but does not play it, and at this time, what is displayed may be an image of the video; if the display type is playing, the display device selects software capable of playing the video to play the video; and if the display type comprises playing and full screen, the display device selects software capable of playing the video to play the video in full screen.

In any one of the embodiments or scenarios, optionally, after the displaying the to-be-displayed content, the method further comprises:

returning a display success message to the request device.

In a possible scenario, the distance between the display device and the request device is a second distance when the display device receives the content display request from the request device. Optionally, the second distance is greater than the first distance.

Specifically, the display device and/or the request device is/are (a) mobile device(s). During the device(s)'s moving process, the distance between the display device and the request device changes. Optionally, the distance is diminishing. Further, if the second distance is greater than the first distance: before a display condition is met, that is, when the distance between the display device and the request device is greater than the first distance, the display device has received the content display request and obtained a part or the whole of the to-be-displayed content, and when the display condition is met, the display device can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request under an instruction of the user or automatically. Multiple display devices, such as a mobile phone, a PAD, and a smart television set, within a broadcasting range of the smart watch all receive the content display request so as to obtain the picture. If the user wants to view specific content on the PAD, the user may go to pick up the PAD. During the user's moving process, the distance between the smart watch and the PAD is accordingly continuously diminishing. When the distance between the smart watch and the PAD reaches a first distance, for example, 0.1 m, the PAD displays the picture.

This embodiment provides a display solution through that the display device receives a content display request from the request device, obtains to-be-displayed content according to the content display request, and displays the to-be-displayed content when the distance between the display device and the request device does not exceed a first distance, and provides a user with choices of the display device through inter-device interactions.

FIG. 2 is a flowchart of Embodiment 2 of a content displaying method provided in the present application. As shown in FIG. 2, this embodiment comprises:

201: A request device sends a content display request of to-be-displayed content to a display device.

Specifically, the to-be-displayed content comprises but not limited to at least one of the followings: a picture, a video, a text message, and the like.

Optionally, the content display request comprises: an identifier and/or address of the to-be-displayed content. Herein, the identifier of the to-be-displayed content may comprise a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address. Accordingly, the display device can obtain a part or the whole of the to-be-displayed content according to the content display request.

In an optional embodiment, the content display request further comprises: a part or the whole of the to-be-displayed content. Accordingly, the display device can obtain a part or the whole of the to-be-displayed content from the content display request.

202: Send a display instruction to the display device in response to the distance between the request device and the display device does not exceed a first distance, wherein the display instruction is used for instructing the display device to display the to-be-displayed content.

In an optional embodiment, the request device determines whether the distance between the request device and the display device does not exceed the first distance, and triggers displaying of the display device in response to a result is yes. Herein, multiple approaches are used for determining. Optionally, the method further comprises:

determining, by the request device, whether the distance between the request device and the display device does not exceed the first distance according to the strength of a signal received from the display device.

Specifically, the BLE is used as an example to introduce how to determine whether an inter-device distance exceeds a certain distance according to signal strength. A proximity profile of the BLE defines how to perform proximity monitoring between two devices, that is, between a monitor and a reporter. The basic principles are as follows:

a monitor first establishes a BLE link with a reporter;

the monitor performs service discovery, wherein relevant services that can be discovered comprise: a link loss service, an immediate alert service, and a Tx Power service;

subsequently, the monitor executes characteristic discovery to obtain characteristics of the three services, for example, a current transmit power value Tx Power provided by the transmit power service; and

thereafter, the monitor continuously detects an RSSI of a signal from the reporter and calculates a link loss according to the following formula:

link loss=Tx Power−RSSI.

On the basis of the principles, in this embodiment, a BLE link is established between the display device and the request device. The request device acts as the monitor and the display device acts as the reporter. The request device detects an RSSI of a signal from the display device, further calculates a link loss between the request device and the display device, compares the link loss obtained through calculation with a preset link loss threshold, wherein the link loss threshold is corresponding to the first distance, that is, the distance between the request device and the display device is the first distance when the link loss between the request device and the display device is the link loss threshold, and if the link loss obtained through calculation does not exceed the link loss threshold, the request device determines that the distance between the request device and the display device does not exceed the first distance. It should be noted that when the environment (such as, a barrier position and air humidity) changes, the distance corresponding to the same link loss may change.

Optionally, the method further comprises:

determining, by the request device, whether the distance between the request device and the display device does not exceed the first distance according to a location of the request device and a location of the display device.

Specifically, the position of the display device and the position of the request device can be obtained through positioning technologies, such as, the GPS positioning and the indoor positioning.

Optionally, the first distance is set by a user, for example, set to be 2 m, 0.5 m, and 0.1 m.

In another optional embodiment, the display device detects to determine whether the distance between the display device and the request device does not exceed the first distance, and triggers the request device to send a display instruction to the display device in response to a result is yes.

In any one of the embodiments or scenarios, optionally, the sending, by a request device, a content display request to a display device comprises:

sending, by the request device, a content display request to the display device in response to the distance between the request device and the display device does not exceed a second distance.

Herein, the second distance is a maximum communication distance between the request device and the display device, and may also be any distance less than the maximum communication distance.

Optionally, the request device determines, by using an approach similar to that of determining whether the distance between the request device and the display device does not exceed the first distance, whether the distance between the request device and the display device does not exceed the second distance. Or, the display device detects to determine whether the distance between the display device and the request device does not exceed the first distance, and triggers the request device to send a content display request to the display device in response to a result is yes.

Optionally, the second distance is greater than the first distance.

Specifically, the display device and/or the request device is/are (a) mobile device(s). During the device(s)'s moving process, the distance between the display device and the request device changes. Optionally, the distance is diminishing. Further, if the second distance is greater than the first distance: before a condition for sending a display instruction is met, that is, when the distance between the request device and the display device is greater than the first distance, the request device has sent a content display request to the display device, the display device obtains a part or the whole of the to-be-displayed content, and when the condition for sending the display instruction is met, the request device sends the display instruction to the display device, and the display device can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request. Multiple display devices, such as a mobile phone, a PAD, and a smart television set, within a broadcasting range of the smart watch all receive the content display request so as to obtain the picture. If the user wants to view specific content on the PAD, the user may go to pick up the PAD. During the user's moving process, the distance between the smart watch and the PAD is accordingly continuously diminishing. When the distance between the smart watch and the PAD reaches a first distance, for example, 0.1 m, the smart watch sends a display instruction to the PAD and the PAD displays the picture.

It should be noted that multiple communication technologies may be used between the request device and the display device to implement interactions. Optionally, the sending, by a request device, a content display request to a display device comprises:

sending, by the request device, a content display request to the display device through a BLE link.

Further optionally, the request device sends a display instruction to the display device through the BLE link.

In any one of the embodiments or scenarios, optionally, the content display request further comprise: a display type. The display type comprises at least one of the followings: opening, playing, zooming in, and full screen. Accordingly, the display instruction is used for instructing the display device to display the to-be-displayed content according to the display type.

This embodiment provides a display solution through that the request device sends a content display request to the display device, wherein the content display request comprises an identifier and/or address of to-be-displayed content, sends a display instruction to the display device when the distance between the request device and the display device does not exceed a first distance, wherein the display instruction is used for instructing the display device to display the to-be-displayed content, and provides a user with choices of the display device through inter-device interactions.

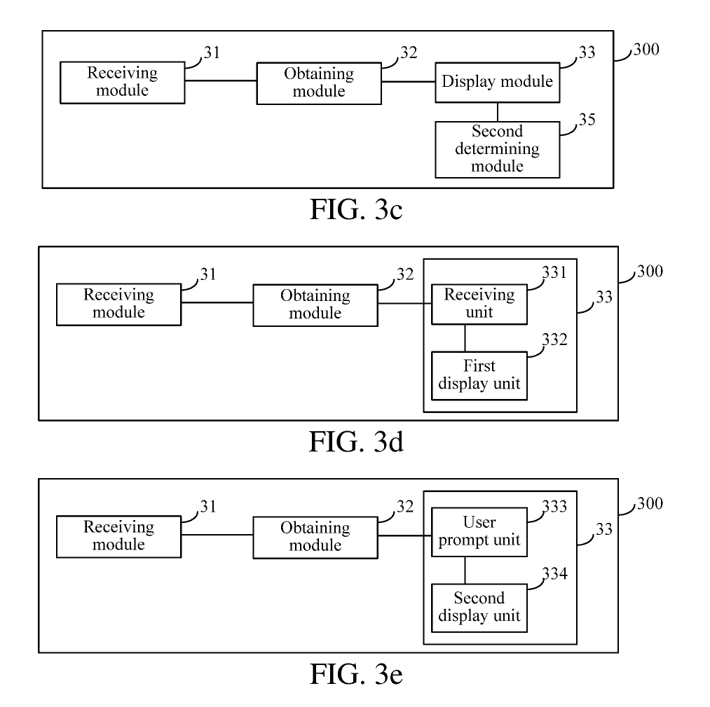

FIG. 3a is a structural diagram of Embodiment 1 of a display device provided in the present application. As shown in FIG. 3a, a display device 300 comprises:

a receiving module 31, configured to receive a content display request from a request device;

an obtaining module 32, configured to obtain to-be-displayed content according to the content display request; and

a display module 33, configured to display the to-be-displayed content when the distance between the display device 300 and the request device does not exceed a first distance.

Optionally, the content display request comprises: an identifier and/or address of the to-be-displayed content. Herein, the identifier of the to-be-displayed content may comprise a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address.

Specifically, the to-be-displayed content comprises but not limited to at least one of: a picture, a video, a text message, and the like.

In an optional embodiment, the obtaining module 32 is further configured to:

obtain a part or the whole of the to-be-displayed content from the display device 300 locally or externally according to the content display request.

For example, if the to-be-displayed content is stored in the display device 300, the content display request may only comprise an identifier of the to-be-displayed content; or, the content display request may only comprise a storage path of the to-be-displayed content in the display device 300; or, the content display request may comprise an identifier of the to-be-displayed content and a storage path of the to-be-displayed content in the display device 300, and accordingly, the obtaining module 32 obtains a part or the whole of the to-be-displayed content locally. If the to-be-displayed content is stored in another device, the content display request may only comprise an identifier of the to-be-displayed content, and accordingly, the obtaining module 32 searches, in a local area network or through a search engine, for and obtains the to-be-displayed content from the another device; or, the content display request may comprise an address of the to-be-displayed content, and accordingly, the obtaining module 32 obtains a part or the whole of the to-be-displayed content from the another device according to the address of the to-be-displayed content.

Generally, if the data size of the to-be-displayed content is small, the obtaining module 32 may obtain the whole of the to-be-displayed content directly. If the data size of the to-be-displayed content is large, the obtaining module 32 may first obtain a part of the to-be-displayed content and further the obtaining module 32 may obtain the other part of the to-be-displayed content during a display process of the display module 33.

In another optional embodiment, the content display request further comprises: a part or the whole of the to-be-displayed content.

Optionally, the obtaining module 32 is further configured to:

obtain a part or the whole of the to-be-displayed content from the content display request.

For example, if the content display request comprises the whole of the to-be-displayed content, the obtaining module 32 obtains the whole of the to-be-displayed content from the content display request, or, first obtains a part of the to-be-displayed content from the content display request and then obtains the other part of the to-be-displayed content from the content display request during a display process of the display module 33. If the content display request comprises a part of the to-be-displayed content and an address of the to-be-displayed content, the obtaining module 32 obtains the part of the to-be-displayed content from the content display request and then obtains the other part of the to-be-displayed content according to the address of the to-be-displayed content during a display process of the display module 33.

In an optional embodiment, the display device 300 determines whether the distance between the display device 300 and the request device does not exceed the first distance, and displays the to-be-displayed content in response to a result is yes. Herein, multiple approaches are used for determining. Optionally, as shown in FIG. 3b, the display device 300 further comprises:

a first determining module 34, configured to determine whether the distance between the display device 300 and the request device does not exceed the first distance according to the strength of a signal received from the request device.

Specifically, the BLE is used as an example to introduce how the first determining module 34 determines whether an inter-device distance exceeds a certain distance according to signal strength. A proximity profile of the BLE defines how to perform proximity monitoring between two devices, that is, between a monitor and a reporter. The basic principles are as follows:

a monitor first establishes a BLE link with a reporter;

the monitor performs service discovery, wherein relevant services that can be discovered comprise: a link loss service, an immediate alert service, and a Tx Power service;

subsequently, the monitor executes characteristic discovery to obtain characteristics of the three services, for example, a current transmit power value Tx Power provided by the transmit power service; and

thereafter, the monitor continuously detects an RSSI of a signal from the reporter and calculates a link loss according to the following formula:

link loss=Tx Power−RSSI.

On the basis of the principles, in this embodiment, a BLE link is established between the display device 300 and the request device. The display device 300 acts as the monitor and the request device acts as the reporter. The first determining module 34 detects an RSSI of a signal from the request device, further calculates a link loss between the display device 300 and the request device, compares the link loss obtained through calculation with a preset link loss threshold, wherein the link loss threshold is corresponding to the first distance, that is, the distance between the display device 300 and the request device is the first distance when the link loss between the display device 300 and the request device is the link loss threshold, and if the link loss obtained through calculation does not exceed the link loss threshold, the first determining module 34 determines that the distance between the display device 300 and the request device does not exceed the first distance. It should be noted that when the environment (such as, a barrier position and air humidity) changes, the distance corresponding to the same link loss may change.

Optionally, as shown in FIG. 3c, the display device 300 further comprises:

a second determining module 35, configured to determine whether the distance between the display device 300 and the request device does not exceed the first distance according to a location of the display device 300 and a location of the request device.

Specifically, the position of the display device 300 and the position of the request device can be obtained through positioning technologies, for example, the GPS positioning and the indoor positioning.

Optionally, the first distance is set by a user, for example, set to be 2 m, 0.5 m, and 0.1 m.

In another optional embodiment, the request device determines whether the distance between the request device and the display device 300 does not exceed the first distance, and triggers displaying of the display module 33 in response to a result is yes. Optionally, as shown in FIG. 3d, the display module 33 comprises:

a receiving unit 331, configured to receive a display instruction from the request device, wherein the display instruction is sent by the request device in response to the request device determines that the distance between the request device and the display device 300 does not exceed the first distance; and

a first display unit 332, configured to display the to-be-displayed content according to the display instruction.

Specifically, the request device determines, by using an approach similar to the above mentioned approach of the first determining module 34, whether the distance between the request device and the display device 300 does not exceed the first distance.

In any one of the embodiments, the user may further be requested for a confirmation before the displaying. Specifically, as shown in FIG. 3e, the display module 33 comprises:

a user prompt unit 333, configured to prompt a user in response to the distance between the display device 300 and the request device does not exceed the first distance; and

a second display unit 334, configured to display the to-be-displayed content according to a display confirmation from the user.

Herein, there are multiple methods for prompting the user by the user prompt unit 333. For example, the user prompt unit 333 presents a window on a display interface of the display device 300, a user is requested to determine whether to perform displaying, and when the user clicks a “confirm” button in the window, the second display unit 334 receives a display confirmation from the user and then performs displaying.

Optionally, if the display confirmation from the user is not received after the user is prompted by the user prompt unit 333, the second display unit 334 does not display the to-be-displayed content.

Optionally, in the embodiment in which the request device detects to determine whether the distance between the request device and the display device 300 does not exceed the first distance, the user prompt unit 333 prompts the user after receiving the display instruction from the request device and the second display unit 334 displays the to-be-displayed content according to the display confirmation from the user.

In an optional embodiment, the content display request further comprises: a display type.

The display type comprises at least one of the followings: opening, playing, zooming in, and full screen.

The display module 33 is further configured to: display the to-be-displayed content according to the display type in response to the distance between the display device 300 and the request device does not exceed the first distance.

Specifically, the corresponding display type may be slightly disparate for different to-be-displayed content. For example, when the to-be-displayed content is a picture: if the display type is opening, the display module 33 selects software capable of opening the picture to open the picture; if the display type is zooming in, the display module 33 zooms in the picture according to a preset multiple on the basis of the opening the picture; and if the display type is full screen, the display module 33 displays the picture in full screen on the basis of the opening the picture. When the to-be-displayed content is a video: if the display type is opening, the display module 33 selects software capable of opening the video to open the video, but does not play it, and at this time, what is displayed may be an image of the video; if the display type is playing, the display module 33 selects software capable of playing the video to play the video; and if the display type comprises playing and full screen, the display module 33 selects software capable of playing the video to play the video in full screen.

In any one of the embodiments or scenarios, optionally, the display device 300 further comprises:

a feedback module, configured to return a display success message to the request device after the to-be-displayed content is displayed on the display module 33.

In a possible scenario, the distance between the display device 300 and the request device is a second distance when the receiving module 31 receives the content display request from the request device. Optionally, the second distance is greater than the first distance.

Specifically, the display device 300 and/or the request device is/are (a) mobile device(s). During the device(s)'s moving process, the distance between the display device 300 and the request device changes. Optionally, the distance is diminishing. Further, if the second distance is greater than the first distance: before a display condition is met, that is, when the distance between the display device 300 and the request device is greater than the first distance, the receiving module 31 has received a content display request and the obtaining module 32 has obtained a part or the whole of the to-be-displayed content, and when the display condition is met, the display module 33 can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request under an instruction of the user or automatically. Multiple display devices, such as a mobile phone, a PAD, and a smart television set, within a broadcasting range of the smart watch all receive the content display request so as to obtain the picture. If the user wants to view specific content on the PAD, the user may go to pick up the PAD. During the user's moving process, the distance between the smart watch and the PAD is accordingly continuously diminishing. When the distance between the smart watch and the PAD reaches a first distance, for example, 0.1 m, the PAD displays the picture.

This embodiment provides a display solution through that the display device receives a content display request from the request device, obtains to-be-displayed content according to the content display request, and displays the to-be-displayed content when the distance between the display device and the request device does not exceed a first distance, and provides a user with choices of the display device through inter-device interactions.

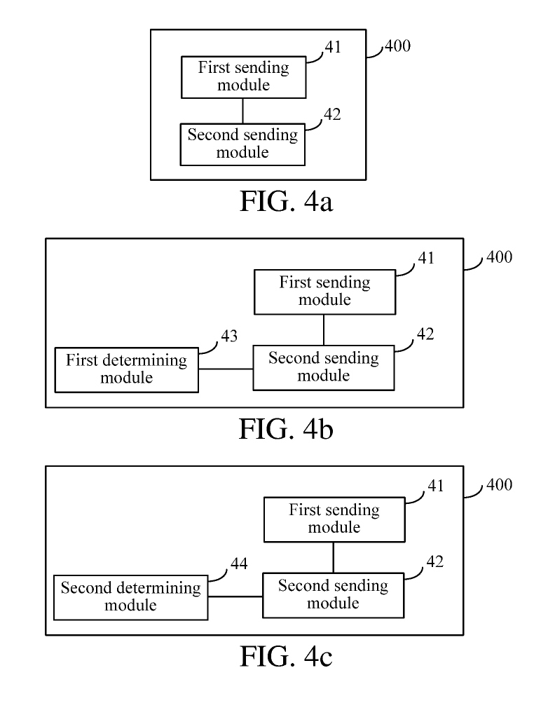

FIG. 4a is a structural diagram of Embodiment 1 of a request device provided in the present application. As shown in FIG. 4a, a request device 400 comprises:

a first sending module 41, configured to send a content display request of to-be-displayed content to a display device; and

a second sending module 42, configured to send a display instruction to the display device in response to the distance between the request device 400 and the display device does not exceed a first distance, wherein the display instruction is used for instructing the display device to display the to-be-displayed content.

Specifically, the to-be-displayed content comprises but not limited to at least one of the followings: a picture, a video, a text message, and the like.

Optionally, the content display request comprises: an identifier and/or address of the to-be-displayed content. Herein, the identifier of the to-be-displayed content may comprise a file name of the to-be-displayed content, or, comprise at least one keyword, a data size, or the like of the to-be-displayed content. The address of the to-be-displayed content is a storage path of the to-be-displayed content in the display device, or, a storage path of the to-be-displayed content in another device and an identifier of the another device, or, a website address. Accordingly, the display device can obtain a part or the whole of the to-be-displayed content according to the content display request.

In an optional embodiment, the content display request further comprises: a part or the whole of the to-be-displayed content. Accordingly, the display device can obtain a part or the whole of the to-be-displayed content from the content display request.

In an optional embodiment, the request device 400 determines whether the distance between the request device 400 and the display device does not exceed the first distance, and triggers the second sending module 42 to send a display instruction to the display device in response to a result is yes. Herein, multiple approaches are used for determination. Optionally, as shown in FIG. 4b, the request device 400 further comprises:

a first determining module 43, configured to determine whether the distance between the request device 400 and the display device does not exceed the first distance according to the strength of a signal received from the display device.

Specifically, the BLE is used as an example to introduce how the first determining module 43 determines whether an inter-device distance exceeds a certain distance according to signal strength. A proximity profile of the BLE defines how to perform proximity monitoring between two devices, that is, between a monitor and a reporter. The basic principles are as follows:

a monitor first establishes a BLE link with a reporter;

the monitor performs service discovery, wherein relevant services that can be discovered comprise: a link loss service, an immediate alert service, and a Tx Power service;

subsequently, the monitor executes characteristic discovery to obtain characteristics of the three services, for example, a current transmit power value Tx Power provided by the transmit power service; and

thereafter, the monitor continuously detects an RSSI of a signal from the reporter and calculates a link loss according to the following formula:

link loss=Tx Power−RSSI.

On the basis of the principles, in this embodiment, a BLE link is established between the display device and the request device 400. The request device 400 acts as the monitor and the display device acts as the reporter. The first determining module 43 detects an RSSI of a signal from the display device, further calculates a link loss between the request device 400 and the display device, compares the link loss obtained through calculation with a preset link loss threshold, wherein the link loss threshold is corresponding to the first distance, that is, the distance between the request device and the display device is the first distance when the link loss between the request device and the display device is the link loss threshold, and if the link loss obtained through calculation does not exceed the link loss threshold, the first determining module 43 determines that the distance between the request device 400 and the display device does not exceed the first distance. It should be noted that when the environment (such as, a barrier position and air humidity) changes, the distance corresponding to the same link loss may change.

Optionally, as shown in FIG. 4c, the request device 400 further comprises:

a second determining module 44, configured to determine whether the distance between the request device 400 and the display device does not exceed the first distance according to a location of the request device 400 and a location of the display device.

Specifically, the position of the display device and the position of the request device 400 can be obtained through positioning technologies, for example, the GPS positioning and the indoor positioning.

Optionally, the first distance is set by a user, for example, set to be 2 m, 0.5 m, and 0.1 m.

In another optional embodiment, the display device detects to determine whether the distance between the display device and the request device 400 does not exceed the first distance, and triggers the second sending module 42 to send a display instruction to the display device in response to a result is yes.

In any one of the embodiments or scenarios, optionally, the first sending module 41 is further configured to:

send a content display request to the display device in response to the distance between the request device 400 and the display device does not exceed a second distance.

Herein, the second distance is a maximum communication distance between the request device 400 and the display device, and may also be any distance less than the maximum communication distance.

Optionally, the first determining module 43 or the second determining module 44 determines, by using an approach similar to that of determining whether the distance between the request device 400 and the display device does not exceed the first distance, whether the distance between the request device 400 and the display device does not exceed the second distance. Or, the display device detects to determine whether the distance between the display device and the request device 400 does not exceed the first distance, and triggers the second sending module 42 to send a content display request to the display device in response to a result is yes.

Optionally, the second distance is greater than the first distance.

Specifically, the display device and/or the request device 400 is/are (a) mobile device(s). During the device(s)'s moving process, the distance between the display device and the request device changes. Optionally, the distance is diminishing. Further, if the second distance is greater than the first distance: before a condition for sending a display instruction is met, that is, when the distance between the request device 400 and the display device is greater than the first distance, the first sending module 41 has sent a content display request to the display device, the display device obtains a part or the whole of the to-be-displayed content, and when the condition for sending the display instruction is met, the second sending module 42 sends the display instruction to the display device and the display device can implement rapid displaying on the basis of the obtained part or whole of the to-be-displayed content.

For example, when a mobile phone receives a picture, a smart watch which is connected to the mobile phone and equipped on a wrist of a user informs the user of the message and displays a thumbnail of the picture. Also, the smart watch acts as a request device and broadcasts a content display request. Multiple display devices, such as a mobile phone, a PAD, and a smart television set, within a broadcasting range of the smart watch all receive the content display request so as to obtain the picture. If the user wants to view specific content on the PAD, the user may go to pick up the PAD. During the user's moving process, the distance between the smart watch and the PAD is accordingly continuously diminishing. When the distance between the smart watch and the PAD reaches a first distance, for example, 0.1 m, the smart watch sends a display instruction to the PAD and the PAD displays the picture.

It should be noted that multiple communication technologies may be used between the request device 400 and the display device to implement interactions. Optionally, the first sending module 41 is further configured to:

send the content display request to the display device through a Bluetooth low energy link when the distance between the request device 400 and the display device does not exceed the second distance.

In any one of the embodiments or scenarios, optionally, the content display request further comprise: a display type. The display type comprises at least one of the followings: opening, playing, zooming in, and full screen. Accordingly, the display instruction is used for instructing the display device to display the to-be-displayed content according to the display type.

This embodiment provides a display solution through that the request device sends a content display request to the display device, wherein the content display request comprises an identifier and/or address of to-be-displayed content, sends a display instruction to the display device when the distance between the request device and the display device does not exceed a first distance, wherein the display instruction is used for instructing the display device to display the to-be-displayed content, and provides a user with choices of the display device through inter-device interactions.

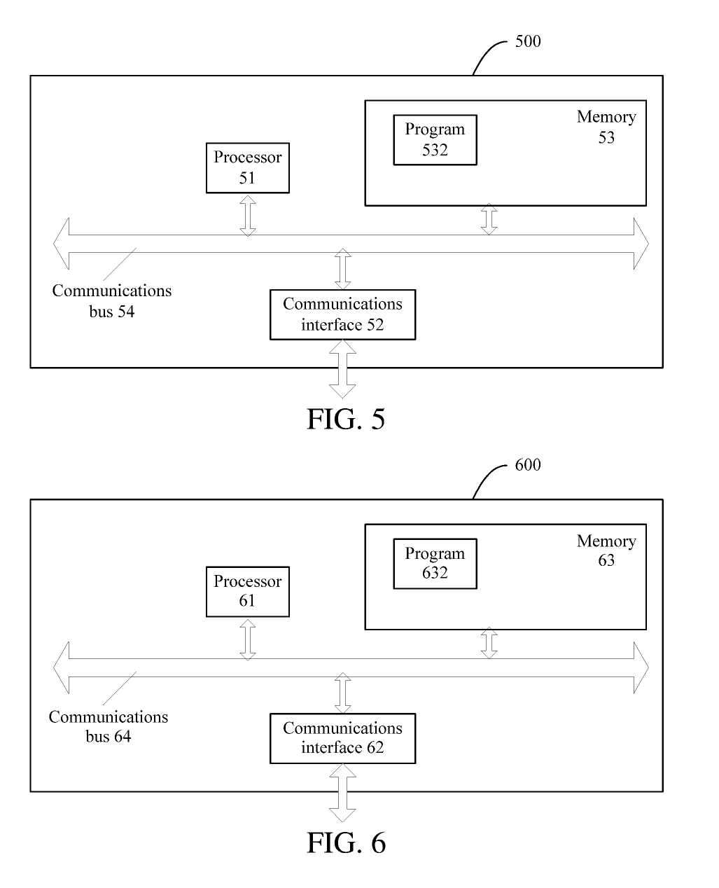

FIG. 5 is a structural diagram of Embodiment 2 of a display device provided in the present application. As shown in FIG. 5, a display device 500 comprises:

a processor 51, a communication interface 52, a memory 53, and a communication bus 54, wherein:

The processor 51, the communication interface 52, and the memory 53 complete mutual communication with each other through the communication bus 54.

The communication interface 52 is configured to perform communication with an external device such as a request device.

The processor 51 is configured to execute a program 532, and specifically may execute relevant steps in Embodiment 1 of the content displaying method.

Specifically, the program 532 may comprise a program code. The program code comprises a computer operating instruction.

The processor 51 may be a central processing unit CPU or an Application Specific Integrated Circuit (ASIC), or be configured to be one or more integrated circuits of Embodiment 1 of the implementation method.

The memory 53 is configured to store the program 532. The memory 53 may comprise a high-speed RAM memory and may also further comprise a non-volatile memory, for example, at least one magnetic disk memory. The program 532 specifically is configured to cause the display device 500 to execute the following steps:

receiving a content display request from a request device;

obtaining to-be-displayed content according to the content display request; and

displaying the to-be-displayed content in response to the distance between the display device 500 and the request device does not exceed a first distance.

Specific implementations of all steps in the program 532 may be referred to in the corresponding description in the corresponding steps and units in Embodiment 1 of the content displaying method, and the details will not be described herein. It can be clearly understood by persons skilled in the art that, for the purpose of convenient and brief description, for a detailed working process of the described devices and modules, reference may be made to the corresponding process in Embodiment 1 of the aforementioned content displaying method, and the details will not be described herein again.

FIG. 6 is a structural diagram of Embodiment 2 of a request device provided in the present application. As shown in FIG. 6, a request device 600 comprises:

a processor 61, a communication interface 62, a memory 63, and a communication bus 64, wherein:

The processor 61, the communication interface 62, and the memory 63 complete mutual communication with each other through the communication bus 64.

The communication interface 62 is configured to perform communication with an external device such as a display device.

The processor 61 is configured to execute a program 632, and specifically may execute a relevant step in Embodiment 2 of the content displaying method.

Specifically, the program 632 may comprise a program code. The program code comprises a computer operating instruction.

The processor 61 may be a central processing unit CPU or an ASIC, or be configured to be one or more integrated circuits of Embodiment 2 of the implementation method.

The memory 63 is configured to store the program 632. The memory 63 may comprise a high-speed RAM memory and may also further comprise a non-volatile memory, for example, at least one magnetic disk memory. The program 632 specifically may be configured to cause the request device 600 to execute the following steps:

sending a content display request to a display device, wherein the content display request comprises an identifier and/or address of to-be-displayed content; and

sending a display instruction to the display device in response to the distance between the request device 600 and the display device does not exceed a first distance, wherein the display instruction is used for instructing the display device to display the to-be-displayed content.

Specific implementations of all steps in the program 632 may be referred to in the corresponding description in the corresponding steps and units in Embodiment 2 of the content displaying method, and the details will not be described herein. It can be clearly understood by persons skilled in the art that, for the purpose of convenient and brief description, for a detailed working process of the described devices and modules, reference may be made to the corresponding process in Embodiment 2 of the aforementioned content displaying method, and the details will not be described herein again.

Persons of ordinary skill in the art should appreciate that, in combination with the examples described in the embodiments herein, units and method steps can be implemented by electronic hardware, or a combination of computer software and electronic hardware. Whether the functions are executed by hardware or software depends on specific applications and design constraint conditions of the technical solutions. Persons skilled in the art can use different methods to implement the described functions for every specific application, but it should not be considered that this implementation goes beyond the scope of the present invention.

When being implemented in the form of a software functional unit and sold or used as a separate product, the functions may be stored in a computer-readable storage medium. Based on such understanding, the technical solutions of the present invention essentially, or the part contributing to the prior art, or part of the technical solutions may be implemented in a form of a software product. The computer software product is stored in a storage medium, and comprises several instructions for instructing a computer device (which may be a personal computer, a server, a network device, and the like) to execute all or part of the steps of the method described in each of the embodiments of the present invention. The aforementioned storage medium comprises: any medium that can store program codes, such as a USB disk, a removable hard disk, a read-only memory (ROM), a random access memory (RAM), a magnetic disk, or an optical disc.

The aforementioned description of the embodiments are merely provided for describing the present application, but not intended to limit the present application. Persons of ordinary skills in the art can also make many variations and changes without departing from the sprint and the scope of protection of the present application. Therefore, all the equivalent technical solutions also fall within the scope of the present application, and the scope of protection of the patent of the present application is limited by the claims.

What is claimed is:

1. A method, comprising:
receiving, by a display device, a content display request from a request device;
obtaining to-be-displayed content according to the content display request; and
displaying the to-be-displayed content in response to a distance between the display device and the request device being determined not to exceed a first distance.

2. The method of claim 1, wherein the content display request comprises: an identifier or an address of the to-be-displayed content.

3. The method of claim 2, wherein the content display request further comprises: a display type,
the display type comprises at least one of an opening, a playing, a zooming in, or a full screen, and
the displaying the to-be-displayed content comprises:
displaying the to-be-displayed content according to the display type.

4. The method of claim 2, wherein the content display request further comprises a part or all of the to-be-displayed content.

5. The method of claim 4, wherein the obtaining the to-be-displayed content according to the content display request comprises:
obtaining the part or all of the to-be-displayed content from the content display request.

6. The method of claim 1, wherein the obtaining the to-be-displayed content according to the content display request comprises:
obtaining a part or all of the to-be-displayed content from the display device locally or externally according to the content display request.

7. The method of claim 1, further comprising:
determining, by the display device, whether the distance between the display device and the request device does not exceed the first distance according to a strength of a signal received from the request device.

8. The method of claim 1, further comprising:
determining, by the display device, whether the distance between the display device and the request device does not exceed the first distance according to a first location of the display device and a second location of the request device.

9. The method of claim 1, wherein the displaying the to-be-displayed content in response to the distance between the display device and the request device does not exceed the first distance comprises:
receiving a display instruction from the request device, wherein the display instruction is sent by the request device in response to the request device determining that the distance between the request device and the display device does not exceed the first distance; and
displaying, by the display device, the to-be-displayed content according to the display instruction.

10. The method of claim 1, wherein the displaying the to-be-displayed content in response to the distance between the display device and the request device does not exceed the first distance comprises:
prompting a user device in response to the distance between the display device and the request device being determined not to exceed the first distance; and
displaying the to-be-displayed content according to a display confirmation from the user device.

11. The method of claim 1, wherein the distance between the display device and the request device is a second distance when the display device receives the content display request from the request device.

12. The method of claim 11, wherein the second distance is greater than the first distance.

13. A method, comprising:
sending, by a request device comprising a processor, a content display request of to-be-displayed content to a display device; and
sending a display instruction to the display device in response to a distance between the request device and the display device being determined not to exceed a first distance, wherein the display instruction is used to instruct the display device to display the to-be-displayed content.

14. The method of claim 13, wherein the sending the content display request to the display device comprises:
sending, by the request device, the content display request to the display device in response to the distance between the request device and the display device being determined not to exceed a second distance.

15. The method of claim 14, wherein the second distance is greater than the first distance.

16. The method of claim 14, wherein the sending, by the request device, the content display request to the display device comprises:
sending, by the request device, the content display request to the display device via a Bluetooth low energy link.

17. The method of claim 13, wherein the content display request comprises an identifier or address of the to-be-displayed content.

18. The method of claim 17, wherein the content display request further comprises a part or all of the to-be-displayed content.

19. The method of claim 13, further comprising:
determining, by the request device, whether the distance between the request device and the display device does not exceed the first distance according to a strength of a signal received from the display device.

20. The method of claim 13, further comprising:
determining, by the request device, whether the distance between the request device and the display device does not exceed the first distance according to a first location of the request device and a second location of the display device.

21. A display device, comprising:
a processor, coupled to a memory, that executes or facilitates execution of executable modules, comprising:
a receiving module configured to receive a content display request from a request device;
an obtaining module configured to obtain to-be-displayed content according to the content display request; and
a display module configured to display the to-be-displayed content in response to determining a distance between the display device and the request device does not exceed a first distance.

22. The display device of claim 21, wherein the content display request comprises an identifier or address of the to-be-displayed content.

23. The display device of claim 22, wherein the content display request further comprises a display type,
the display type comprises at least one of an opening, a playing, a zooming in, or a full screen, and
the display module is further configured to:
display the to-be-displayed content according to the display type in response to the distance between the display device and the request device being determined not to exceed the first distance.

24. The display device of claim 22, wherein the content display request further comprises a part or all of the to-be-displayed content.

25. The display device of claim 24, wherein the obtaining module is further configured to:
obtain a part or all of the to-be-displayed content from the content display request.

26. The display device of claim 21, wherein the obtaining module is further configured to:
obtain a part or all of the to-be-displayed content from the display device locally or externally according to the content display request.

27. The display device of claim 21, wherein the display device further comprises:
a first determining module configured to determine whether the distance between the display device and the request device does not exceed the first distance according to a strength of a signal received from the request device.

28. The display device of claim 21, wherein the display device further comprises:
a second determining module configured to determine whether the distance between the display device and the request device does not exceed the first distance according to a first location of the display device and a second location of the request device.

29. The display device of claim 21, wherein the display module comprises:
a receiving unit configured to receive a display instruction from the request device, wherein the display instruction is sent by the request device in response to the request device determining that the distance between the request device and the display device does not exceed the first distance; and
a first display unit configured to display the to-be-displayed content according to the display instruction.

30. The display device of claim 21, wherein the display module comprises:
a user prompt unit configured to prompt a user in response to the distance between the display device and the request device being determined not to exceed the first distance; and
a second display unit configured to display the to-be-displayed content according to a display confirmation from the user.

31. The display device of claim 21, wherein the distance between the display device and the request device is a second distance when the receiving module receives the content display request from the request device.

32. The display device of claim 31, wherein the second distance is greater than the first distance.

33. A request device, comprising:
a processor, coupled to a memory, that executes or facilitates execution of executable modules, comprising:
a first sending module configured to send a content display request of to-be-displayed content to a display device; and
a second sending module configured to send a display instruction to the display device in response to a distance between the request device and the display device being determined not to exceed a first distance, wherein the display instruction is used to instruct the display device to display the to-be-displayed content.

34. The request device of claim 33, wherein the first sending module is further configured to:
send a content display request to the display device in response to the distance between the request device and the display device being determined not to exceed a second distance.

35. The request device of claim 34, wherein the second distance is greater than the first distance.

36. The request device of claim 34, wherein the first sending module is further configured to:
send the content display request to the display device through a Bluetooth low energy link in response to the distance between the request device and the display device being determined not to exceed the second distance.

37. The request device of claim 33, wherein the content display request comprises at least one of an identifier or an address of the to-be-displayed content.

38. The request device of claim 37, wherein the content display request further comprises: at least part of the to-be-displayed content.

39. The request device of claim 33, wherein the request device further comprises:
a first determining module configured to determine whether the distance between the request device and the display device does not exceed the first distance according to a strength of a signal received from the display device.

40. The request device of claim 33, wherein the request device further comprises:
a first determining module configured to determine whether the distance between the request device and the display device does not exceed the first distance according to a location of the request device and another location of the display device.

41. A computer readable storage device comprising executable instructions that, in response to execution, cause a display device comprising a processor to perform operations, comprising:
receiving a content display request from a request device;
obtaining to-be-displayed content according to the content display request; and
displaying the to-be-displayed content in response to a distance between the display device and the request device not exceeding a first distance.

42. A computer readable storage device comprising executable instructions that, in response to execution, cause a request device comprising a processor to perform operations, comprising:
sending a content display request of to-be-displayed content to a display device; and
sending a display instruction to the display device in response to a distance between the request device and the display device not exceeding a first distance, wherein the display instruction is used to instruct the display device to display the to-be-displayed content.
